(19) United States
(12) Patent Application Publication
(10) Pub. No.: US 2026/0028946 A1
(43) Pub. Date: Jan. 29, 2026

(54) HINGE ASSEMBLY FOR A THRUST REVERSER FIXED STRUCTURE

(71) Applicant: Rohr, Inc., Chula Vista, CA (US)

(72) Inventor: Christopher J. Roberts, El Cajon, CA (US)

(21) Appl. No.: 18/781,380

(22) Filed: Jul. 23, 2024

(51) Int. Cl. F02K 1/62; F02K 1/70

(52) U.S. Cl. CPC F02K 1/62; F02K 1/70

(57) ABSTRACT

A thrust reverser assembly includes a pylon, an outer fixed structure, an inner fixed structure, and a hinge assembly. The outer fixed structure extends about an axial centerline. The outer fixed structure includes a first outer body half. The inner fixed structure extends about the axial centerline. The inner fixed structure includes a first inner body half. The hinge assembly includes a first hinge member and a second hinge member. The first hinge member is pivotably mounted to the pylon about a first pivot axis. The second hinge member is pivotably mounted to the first hinge member about the first pivot axis. The first hinge member pivotably mounts the first outer body half to the pylon to pivot about the first pivot axis. The second hinge member pivotably mounts the first inner body half to the first outer body half to pivot about the first pivot axis independent of the first outer body half.

### BACKGROUND

### Technical Field

This disclosure relates generally to a thrust reverser for an aircraft propulsion system and, more particularly, to a hinge assembly for a thrust reverser fixed structure.

### Background Information

Aircraft propulsion systems may include thrust reversers configured for redirecting air flow in an at least partially forward direction to generate reverse thrust for the propulsion system. Some thrust reversers include inner and outer fixed structures configured to support translating and/or air flow blocking components of the thrust reverser. Various inner fixed structure and outer fixed structure assemblies are known in the art. While these known assemblies may be suitable for their intended purposes, there is always room in the art for improvement.

### SUMMARY

It should be understood that any or all of the features or embodiments described herein can be used or combined in any combination with each and every other feature or embodiment described herein unless expressly noted otherwise.

According to an aspect of the present disclosure, a thrust reverser assembly for an aircraft propulsion system includes a pylon, an outer fixed structure, an inner fixed structure, and a hinge assembly. The outer fixed structure extends about an axial centerline. The outer fixed structure forms an outer-radial boundary of a bypass flow path through the thrust reverser assembly. The outer fixed structure includes a first outer body half. The inner fixed structure extends about the axial centerline. The inner fixed structure forms an inner-radial boundary of the bypass flow path through the thrust reverser assembly. The inner fixed structure includes a first inner body half. The hinge assembly includes a first hinge member and a second hinge member. The first hinge member is pivotably mounted to the pylon about a first pivot axis. The second hinge member is pivotably mounted to the first hinge member about the first pivot axis. The first hinge member pivotably mounts the first outer body half to the pylon to pivot about the first pivot axis between a closed first outer body position and an open first outer body position. The second hinge member pivotably mounts the first inner body half to the first outer body half to pivot about the first pivot axis between a closed first inner body position and an open first inner body position independent of the first outer body half.

In any of the aspects or embodiments described above and herein, the outer fixed structure may include a second outer body half, the inner fixed structure may include a second inner body half, and the hinge assembly may include a third hinge member and a fourth hinge member. The third hinge member may be pivotably mounted to the pylon about a second pivot axis. The fourth hinge member may be pivotably mounted to the third hinge member about the second pivot axis. The third hinge member may pivotably mount the second outer body half to the pylon to pivot about the second pivot axis between a closed second outer body position and an open second outer body position. The second hinge member may pivotably mount the second inner body half to the second outer body half to pivot about the second pivot axis between a closed second inner body position and an open second inner body position independent of the second outer body half.

In any of the aspects or embodiments described above and herein, the outer fixed structure may include an outer latch assembly configured to secure the first outer body half and the second outer body half together in the closed first outer body position and the closed second outer body position, respectively. The inner fixed structure may include an inner latch assembly configured to secure the first inner body half and the second inner body half together in the closed first inner body position and the closed second inner body position, respectively.

In any of the aspects or embodiments described above and herein, the first hinge member may include a first hinge member body. The first hinge member body may include one or more inner fixed structure (IFS) attachment members. The second hinge member may include a second hinge member body. The second hinge member body may include one or more outer fixed structure (OFS) attachment members. Each of the OFS attachment members may be pivotably mounted to a respective one of the IFS attachment members along the first pivot axis.

In any of the aspects or embodiments described above and herein, the first hinge member body may include one or more pylon attachment members. The pylon attachment members may be pivotably mounted to the pylon along the first pivot axis.

In any of the aspects or embodiments described above and herein, the IFS attachment members may be pivotably mounted to the pylon along the first pivot axis.

In any of the aspects or embodiments described above and herein, each of the OFS attachment members may be pivotably mounted to the respective one of the IFS attachment members by a support bushing and a hinge pin. The hinge pin may be pivotably mounted to the pylon along the first pivot axis.

In any of the aspects or embodiments described above and herein, the hinge assembly may include a seal mounted to the second hinge member body. The first hinge member body may contact the seal with the first outer body half and the first inner body half in the closed first outer body position and the closed first inner body position, respectively.

In any of the aspects or embodiments described above and herein, the hinge assembly may include a seal mounted to the first hinge member body. The first inner body half may contact the seal with the first outer body half and the first inner body half in the closed first outer body position and the closed first inner body position, respectively.

According to another aspect of the present disclosure, a thrust reverser assembly for an aircraft propulsion system includes a pylon, an outer fixed structure, an inner fixed structure, and a hinge assembly. The outer fixed structure extends about an axial centerline. The outer fixed structure includes a first outer body half, a second outer body half, and an outer latch assembly. Each of the first outer body half and the second outer body half is pivotable between a closed outer body position and an open outer body position. The outer latch assembly is configured to retain the first outer body half and the second outer body half together with both of the first outer body half and the second outer body in the closed outer body position. The inner fixed structure extends about the axial centerline. The inner fixed structure includes a first inner body half, a second inner body half, and an inner latch assembly. Each of the first inner body half and the second inner body half is pivotable between a closed inner body position and an open inner body position. The inner latch assembly is configured to retain the first inner body half and the second inner body half together with both of the first inner body half and the second inner body in the closed inner body position. The hinge assembly pivotably mounts the first outer body half to the pylon at a first pivot axis. The hinge assembly pivotably mounts the first inner body half to the first outer body half at the first pivot axis. The first outer body half and the first inner body half are independently pivotable about the first pivot axis. The hinge assembly pivotably mounts the second outer body half to the pylon at a second pivot axis. The hinge assembly pivotably mounts the second inner body half to the second outer body half at the second pivot axis. The second outer body half and the second inner body half are independently pivotable about the second pivot axis.

In any of the aspects or embodiments described above and herein, each of the first outer body half and the second outer body half may be pivotably mounted to the pylon by a first hinge member of the hinge assembly.

In any of the aspects or embodiments described above and herein, each of the first inner body half and the second inner body half may be pivotably mounted to the first outer body half and the second outer body half, respectively, by a second hinge member of the hinge assembly.

In any of the aspects or embodiments described above and herein, the first hinge member and the second hinge member may be pivotably mounted to the pylon by a support bushing.

In any of the aspects or embodiments described above and herein, the second hinge member may include a seal. The first hinge member may be configured to contact the seal with the first outer body half and the second outer body half in the closed outer body position and the first inner body half and the second inner body half in the closed inner body position.

According to another aspect of the present disclosure, a thrust reverser assembly for an aircraft propulsion system includes a pylon, an outer fixed structure, an inner fixed structure, and a hinge assembly. The outer fixed structure extends about an axial centerline. The outer fixed structure forms an outer-radial boundary of a bypass flow path through the thrust reverser assembly. The outer fixed structure includes a first outer body half. The inner fixed structure extends about the axial centerline. The inner fixed structure forms an inner-radial boundary of the bypass flow path through the thrust reverser assembly. The inner fixed structure includes a first inner body half. The hinge assembly includes a first hinge member and a second hinge member. The first hinge member is pivotably mounted to the pylon along a first pivot axis. The first hinge member includes a first hinge member body. The first hinge member body includes one or more inner fixed structure (IFS) attachment members. The second hinge member includes a second hinge member body. The second hinge member body includes one or more outer fixed structure (OFS) attachment members. Each of the OFS attachment members is pivotably mounted to a respective one of the IFS attachment members along the first pivot axis.

In any of the aspects or embodiments described above and herein, the first hinge member body may include one or more pylon attachment members. The pylon attachment members may be pivotably mounted to the pylon along the first pivot axis.

In any of the aspects or embodiments described above and herein, the pylon attachment members may be alternatingly arrayed with the IFS attachment members along the first pivot axis.

In any of the aspects or embodiments described above and herein, the IFS attachment members may be pivotably mounted to the pylon along the first pivot axis.

In any of the aspects or embodiments described above and herein, the hinge assembly may include a seal mounted to the second hinge member body. The first hinge member body may be configured to contact the seal.

In any of the aspects or embodiments described above and herein, the hinge assembly may include a seal mounted to the first hinge member body. The first inner body half may be configured to contact the seal.

The present disclosure, and all its aspects, embodiments and advantages associated therewith will become more readily apparent in view of the detailed description provided below, including the accompanying drawings.

### BRIEF DESCRIPTION OF THE DRAWINGS

FIG. 1 schematically illustrates an exterior of a propulsion system for an aircraft with a thrust reverser of the propulsion system in a stowed condition, in accordance with one or more embodiments of the present disclosure.

FIG. 2 schematically illustrates an exterior of the propulsion system with the thrust reverser in a deployed condition, in accordance with one or more embodiments of the present disclosure.

FIG. 3 schematically illustrates a cutaway, side view of the propulsion system, in accordance with one or more embodiments of the present disclosure.

FIG. 4 schematically illustrates a cutaway view of a portion of the thrust reverser with an outer fixed structure and an inner fixed structure of the thrust reverser in their respective closed conditions, in accordance with one or more embodiments of the present disclosure.

FIG. 5 schematically illustrates a cutaway view of a portion of the thrust reverser with the outer fixed structure in its open condition and the inner fixed structure in its closed condition, in accordance with one or more embodiments of the present disclosure.

FIG. 6 schematically illustrates a cutaway view of a portion of the thrust reverser with the outer fixed structure and the inner fixed structure in their respective open conditions, in accordance with one or more embodiments of the present disclosure.

FIG. 7 illustrates a perspective view of a hinge assembly for the outer fixed structure and the inner fixed structure, in accordance with one or more embodiments of the present disclosure.

FIG. 8 illustrates a cross-sectional view of the hinge assembly taken along Line 8-8 of FIG. 7, in accordance with one or more embodiments of the present disclosure.

FIG. 9 a perspective view of another hinge assembly for the outer fixed structure and the inner fixed structure, in accordance with one or more embodiments of the present disclosure.

FIG. 10 illustrates a perspective view of a hinge assembly for the outer fixed structure and the inner fixed structure, in accordance with one or more embodiments of the present disclosure.

FIG. 11 illustrates a cross-sectional view of the hinge assembly taken along Line 11-11 of FIG. 10, in accordance with one or more embodiments of the present disclosure.

FIG. 12 a perspective view of another hinge assembly for the outer fixed structure and the inner fixed structure, in accordance with one or more embodiments of the present disclosure.

### DETAILED DESCRIPTION

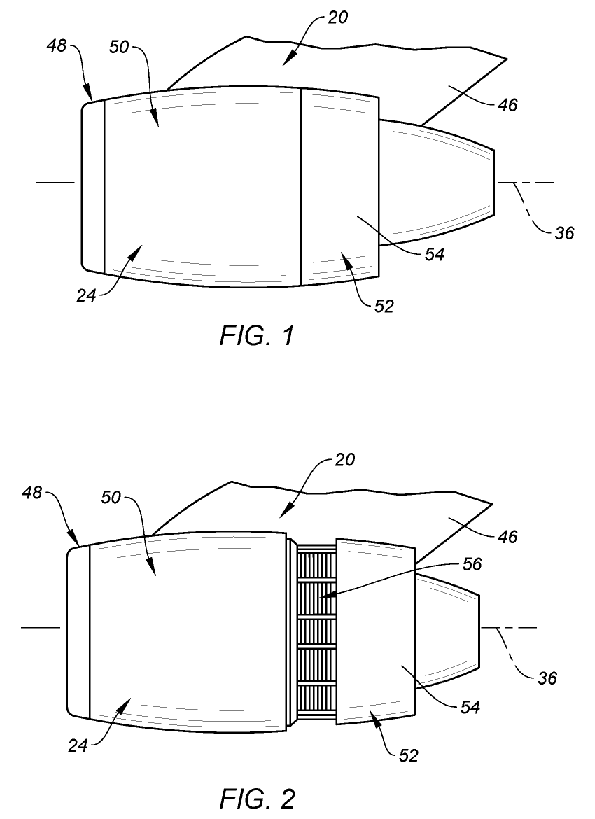

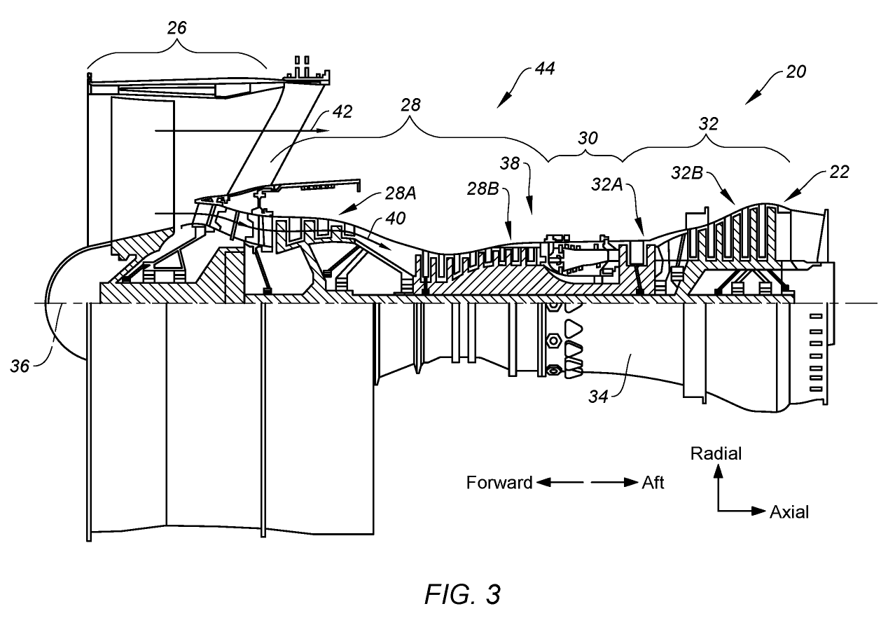

FIGS. 1-3 illustrate a propulsion system 20 for an aircraft. The propulsion system 20 includes a gas turbine engine 22 and a nacelle 24. This gas turbine engine 22 may be configured as a high-bypass turbofan engine. Alternatively, the gas turbine engine 22 may be configured as any other type of gas turbine engine capable of propelling the aircraft during flight.

The gas turbine engine 22 includes a fan section 26, a compressor section 28, a combustor section 30, a turbine section 32, and an engine static structure 34. The gas turbine engine 22 sections 26, 28, 30, 32 of FIG. 1 are arranged sequentially along an axial centerline 36 (e.g., a rotational axis) of the gas turbine engine 22. The compressor section 28 may include a low-pressure compressor (LPC) 28A and a high-pressure compressor (HPC) 28B. The turbine section 32 may include a high-pressure turbine (HPT) 32A and a low-pressure turbine (LPT) 32B. The present disclosure, however, is not limited to the particular gas turbine engine 22 configuration of FIG. 2. The gas turbine engine 22 sections 26, 28, 30, 32 form an engine core 38 of the gas turbine engine 22.

The engine static structure 34 may include, for example, one or more engine cases for the gas turbine engine 22. The engine static structure 34 may additionally include cowlings, bearing assemblies, and/or other structural components of the gas turbine engine 22. The one or more engine cases form, house, and/or structurally support components of the gas turbine engine 22 sections 26, 28, 30, 32.

In operation of the gas turbine engine 22, ambient air is directed through the fan section 26 and into a core flow path 40 (e.g., an inner annular flow path) and a bypass flow path 42 (e.g., an outer annular flow path). Air flow along the core flow path 40 is compressed by the low-pressure compressor 28A and the high-pressure compressor 28B, mixed and burned with fuel in the combustor section 30, and then directed through the high-pressure turbine 32A and the low-pressure turbine 32B. The high-pressure turbine 32A and the low-pressure turbine 32B rotationally drive the high-pressure compressor 28B and the low-pressure compressor 28A, respectively, in response to the combustion gas flow through the high-pressure turbine 32A and the low-pressure turbine 32B. Air flow is directed through the propulsion system 20 along the bypass flow path 42 through a bypass duct 44 formed by and between the gas turbine engine 22 and the nacelle 24. This air flow through the bypass duct 44 is exhausted from the propulsion system 20 to facilitate propulsive thrust for the propulsion system 20 and its associated aircraft.

The nacelle 24 is configured to structurally support, house, and provide an aerodynamic cover for the gas turbine engine 22. The nacelle 24 may also mount or facilitate mounting of the propulsion system 20 to an aircraft. For example, the nacelle 24 of FIGS. 1-2 is mounted to a pylon 46 configured to facilitate mounting of the propulsion system 20 to an aircraft. The nacelle 24 of FIG. 1 generally includes an air intake 48, a fan cowl 50, and a thrust reverser 52. As shown in FIGS. 1-2, at least a portion of the thrust reverser 52 may be configured to move (e.g., axially translate) relative to the air intake 48 and the fan cowl 50 to facilitate reverse thrust for the propulsion system 20 by directing air from the bypass duct 44 out of the propulsion system 20 in an at least partially axially forward direction. For example, the thrust reverser 52 of FIGS. 1 and 2 includes a translating sleeve 54. The translating sleeve 54 is axially translatable (e.g., relative to the axial centerline 36 between a stowed position (see FIG. 1) and a deployed position (FIG. 2). With the translating sleeve 54 in the deployed position, the thrust reverser 52 directs air from the bypass duct 44 into and through cascades 56 (e.g., an array of flow-turning vanes) in an at least partially axially forward direction to generate reverse thrust.

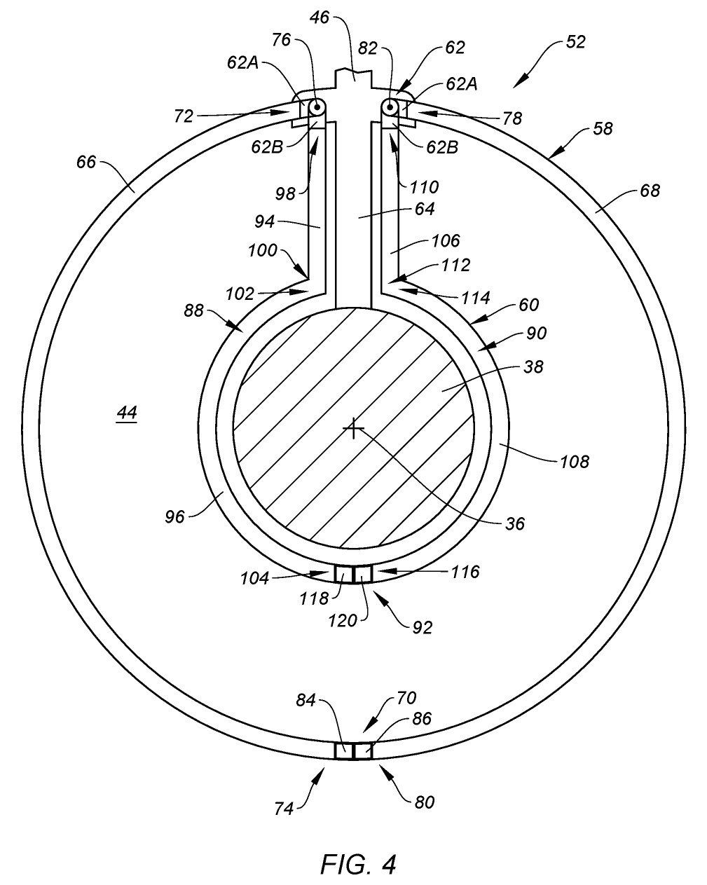

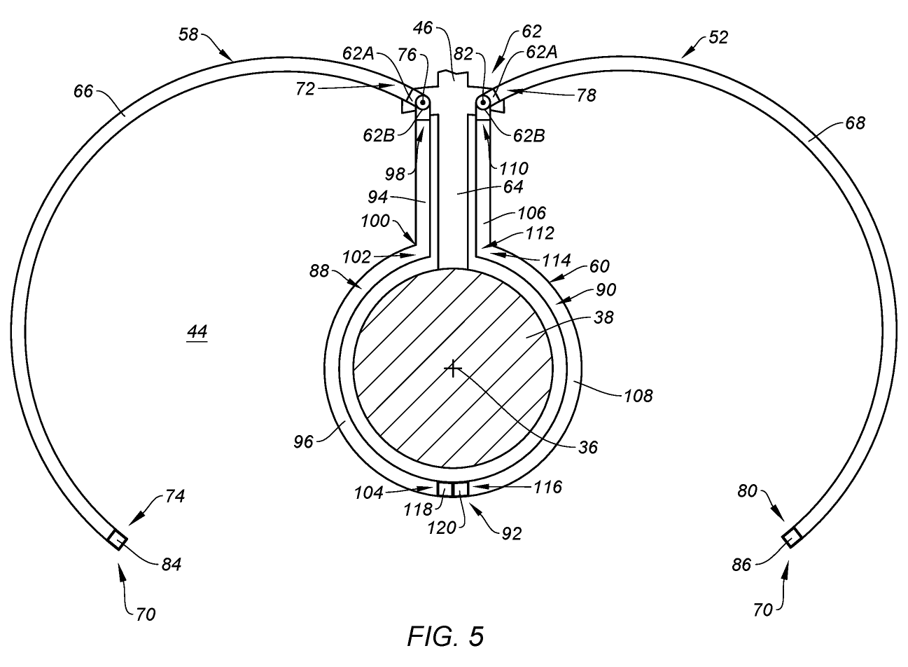

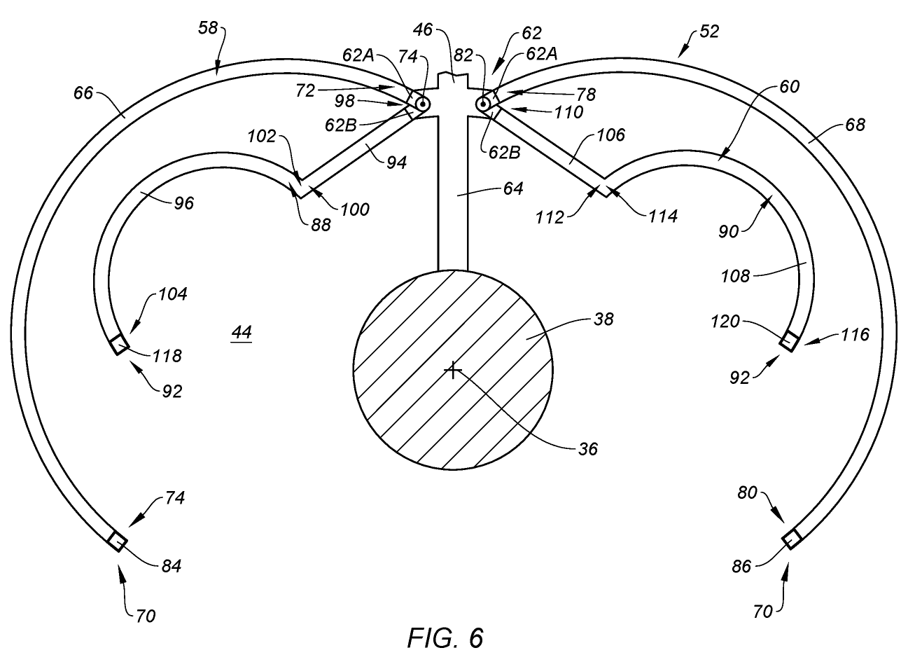

FIGS. 4-6 schematically illustrate cutaway views of the thrust reverser 52, for example, along a plane orthogonal to the axial centerline 36. In particular, FIGS. 4-6 illustrate an outer fixed structure (OFS) 58, an inner fixed structure (IFS) 60, and a hinge assembly 62 of the thrust reverser 52. The outer fixed structure 58 and the inner fixed structure 60 form an axial portion of the bypass duct 44 through the propulsion system 20 therebetween. The outer fixed structure 58 and the inner fixed structure 60 may support movable components of the thrust reverser 52 which facilitate reverse thrust such as, but not limited to, the translating sleeve 54. Each of the outer fixed structure 58 and the inner fixed structure 60 is positionable in a closed condition and an open condition. FIG. 4 illustrates the outer fixed structure 58 and the inner fixed structure 60 in their respective closed conditions. FIG. 5 illustrates the outer fixed structure 58 in its open condition and the inner fixed structure in its closed condition. FIG. 6 illustrates the outer fixed structure 58 and the inner fixed structure 60 in their respective open conditions. The term “fixed,” as used herein for the outer fixed structure 58 and the inner fixed structure 60, refers to the fixed axial positioning of the outer fixed structure 58 and the inner fixed structure 60 (e.g., the outer fixed structure 58 and the inner fixed structure 60 are not axially-translating components of the thrust reverser 52) and, as will be discussed in further detail, the outer fixed structure 58 and the inner fixed structure 60 are movable between and to their respective closed conditions and open conditions. The hinge assembly 62 includes a pair of first hinge members 62A and a pair of second hinge members 62B.

FIGS. 4-6 further schematically illustrate a portion of the pylon 46 mounted to and supporting the gas turbine engine 22 (e.g., the engine core 38) and the nacelle 24 (e.g., the outer fixed structure 58 and the inner fixed structure 60). The pylon 46 of FIGS. 4-6 forms an upper bifurcation 64 at (e.g., on, adjacent, or proximate) a twelve o’clock position of the thrust reverser 52.

The outer fixed structure 58 extends circumferentially about the axial centerline 36. The outer fixed structure 58 surrounds and forms an outer radial boundary of the bypass duct 44. The outer fixed structure 58 is formed by two structural body portions including a first body half 66 and a second body half 68. The outer fixed structure 58 further includes a latch assembly 70.

The first body half 66 extends between and to a first circumferential end 72 of the first body half 66 and a second circumferential end 74 of the first body half 66. The first body half 66 is pivotably mounted to the pylon 46 by the hinge assembly 62 at (e.g., on, adjacent, or proximate) the first circumferential end 72. The first body half 66 is pivotably mounted to the pylon 46 by one of the first hinge members 62A. The first hinge member 62A is disposed at (e.g., on, adjacent, or proximate) the first circumferential end 72. The first hinge member 62A may be formed by the first body half 66 or otherwise mounted to the first body half 66 at (e.g., on, adjacent, or proximate) the first circumferential end 72. The first hinge member 62A is pivotably mounted to the pylon 46 at a first pivot axis 76. The first body half 66 is pivotable relative to the pylon 46 about the first pivot axis 76 between a closed position and an open position, corresponding to the respective closed condition and open condition of the outer fixed structure 58.

The second body half 68 extends between and to a first circumferential end 78 of the second body half 68 and a second circumferential end 80 of the second body half 68. The second body half 68 is pivotably mounted to the pylon 46 by the hinge assembly 62 at (e.g., on, adjacent, or proximate) the first circumferential end 78. The second body half 68 is pivotably mounted to the pylon 46 by the other of the first hinge members 62A. The first hinge member 62A is disposed at (e.g., on, adjacent, or proximate) the first circumferential end 78. The first hinge member 62A may be formed by the first body half 68 or otherwise mounted to the first body half 68 at (e.g., on, adjacent, or proximate) the first circumferential end 78. The first hinge member 62A is pivotably mounted to the pylon 46 at a second pivot axis 82. The first body half 68 is pivotable relative to the pylon 46 about the second pivot axis 82 between a closed position and an open position, corresponding to the respective closed condition and open condition of the outer fixed structure 58.

The latch assembly 70 includes a first latch portion 84 and a second latch portion 86. The first latch portion 84 is disposed on the first body half 66 at (e.g., on, adjacent, or proximate) the second circumferential end 74. The second latch portion 86 is disposed on the first body half 68 at (e.g., on, adjacent, or proximate) the second circumferential end 80. The first latch portion 84 is selectively engageable with the second latch portion 86 with the first body half 66 and the second body half 68 in their respective closed positions. The first latch portion 84 engaged with the second latch portion 86 retains (e.g., latches) the first body half 66 and the second body half 68 together in their respective closed positions.

The inner fixed structure 60 is disposed radially inward of the outer fixed structure 58. The inner fixed structure 60 forms an inner radial boundary of the bypass duct 44. The inner fixed structure 60 extends circumferentially about a portion of the engine core 38. The inner fixed structure 60 is formed by two structural body portions including a first body half 88 and a second body half 90. The inner fixed structure 60 further includes a latch assembly 92.

The first body half 88 includes a panel portion 94 and an arcuate portion 96. The panel portion 94 extends (e.g., generally linearly) between and to a first end 98 of the panel portion 94 and a second end 100 of the panel portion 94. The first body half 88 is pivotably mounted to the pylon 46 by the hinge assembly 62 at (e.g., on, adjacent, or proximate) the first end 98. The first body half 88 is pivotably mounted to a respective one of the first hinge members 62A by one of the second hinge members 62B. The second hinge member 62B is disposed at (e.g., on, adjacent, or proximate) the first end 98. The second hinge member 62B may be formed by the first body half 88 or otherwise mounted to the first body half 88 at (e.g., on, adjacent, or proximate) the first end 98. The second hinge member 62B is pivotably mounted to the first hinge member 62A at the first pivot axis 76. The first body half 66 and the first body half 88 are independently pivotable about the first pivot axis 76. The first body half 88 is pivotable about the first pivot axis 76 between a closed position and an open position, corresponding to the respective closed condition and open condition of the inner fixed structure 60. The arcuate portion 96 extends between and to a first circumferential end 102 of the arcuate portion 94 and a second circumferential end 104 of the arcuate portion 94. The first circumferential end 102 is disposed at (e.g., on, adjacent, or proximate) the second end 100. The arcuate portion 96 extends circumferentially about the axial centerline 36 with the first body half 88 in its closed position.

The second body half 90 includes a panel portion 106 and an arcuate portion 108. The panel portion 106 extends (e.g., generally linearly) between and to a first end 110 of the panel portion 106 and a second end 112 of the panel portion 106. As will be discussed in further detail, the second body half 90 is pivotably mounted to the pylon 46 by the hinge assembly 62 at (e.g., on, adjacent, or proximate) the first end 110. The second body half 90 is pivotably mounted to a respective one of the first hinge members 62A by the other of the second hinge members 62B. The second hinge member 62B is disposed at (e.g., on, adjacent, or proximate) the first end 110. The second hinge member 62B may be formed by the second body half 90 or otherwise mounted to the second body half 90 at (e.g., on, adjacent, or proximate) the first end 110. The second hinge member 62B is pivotably mounted to the first hinge member 62A at the second pivot axis 82. The second body half 68 and the second body half 90 are independently pivotable about the second pivot axis 82. The second body half 90 is pivotable about the second pivot axis 82 between a closed position and an open position, corresponding to the respective closed condition and open condition of the inner fixed structure 60. The arcuate portion 108 extends between and to a first circumferential end 114 of the arcuate portion 108 and a second circumferential end 116 of the arcuate portion 108. The first circumferential end 114 is disposed at (e.g., on, adjacent, or proximate) the second end 112. The arcuate portion 108 extends circumferentially about the axial centerline 36 with the second body half 90 in its closed position.

The latch assembly 92 includes a first latch portion 118 and a second latch portion 120. The first latch portion 118 is disposed on the first body half 88 at (e.g., on, adjacent, or proximate) the second circumferential end 104. The second latch portion 120 is disposed on the second body half 90 at (e.g., on, adjacent, or proximate) the second circumferential end 116. The first latch portion 118 is selectively engageable with the second latch portion 120 with the first body half 88 and the second body half 90 in their respective closed positions. The first latch portion 118 engaged with the second latch portion 120 retains (e.g., latches) the first body half 88 and the second body half 90 together in their respective closed positions.

As previously discussed, the body halves 66, 68 of the outer fixed structure 58 and the body halves 88, 90 of the inner fixed structure 60 are independently pivotable about the first pivot axis 76 and the second pivot axis 82, respectively. For example, as shown in FIG. 6 to FIG. 5, the body halves 88, 90 of the inner fixed structure 60 may be pivoted from their respective open positions to their respective closed positions while the outer fixed structure 58 remains in its closed condition. This independent configuration of the outer fixed structure 58 and the inner fixed structure 60 facilitates access to and operation of the latch assembly 92 (e.g., by an operator) while the outer fixed structure remains in its closed condition, in contrast to at least some conventional thrust reverser assemblies in which the outer fixed structure and the inner fixed structure may be configured only for pivoting open and closed together. As shown in FIG. 5 to FIG. 4, the body halves 66, 68 of the outer fixed structure 58 may be pivoted from their respective open positions to their respective closed positions subsequent to closing and latching the inner fixed structure 60.

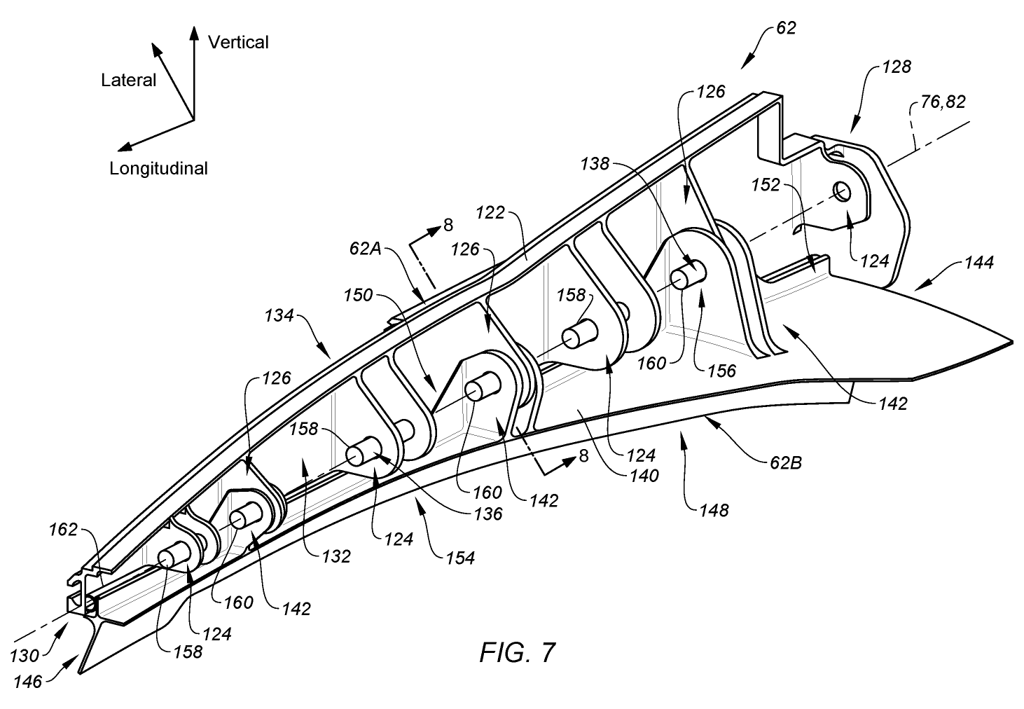

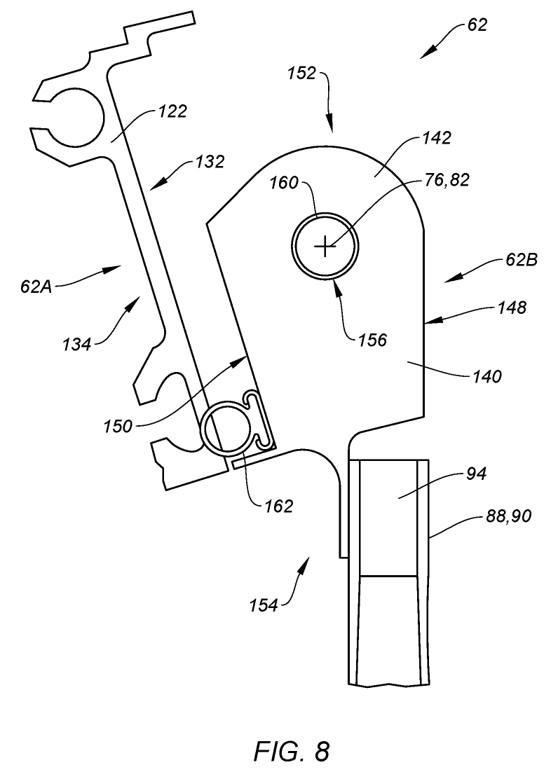

FIGS. 7-8 illustrate an embodiment of the hinge assembly 62. FIG. 7 illustrates a perspective view of one of the first hinge members 62A and a respective one of the second hinge members 62B. FIG. 7 illustrates the first hinge member 62A and the second hinge member 62B for the first body half 66 and the first body half 88, respectively. However, the description of the first hinge member 62A and the second hinge member 62B may be understood as being equally applicable to the first hinge member 62A and the second hinge member 62B for the second body half 68 and the second body half 90, respectively FIG. 8 illustrates a cross-sectional view of the first hinge member 62A and the second hinge member 62B of FIG. 7 taken along Line 8-8 of FIG. 7.

The first hinge member 62A includes a first hinge member body 122, one or more pylon hinge attachment members 124, and one or more IFS hinge attachment members 126. The first hinge member body 122 extends longitudinally (e.g., in a direction of the first pivot axis 76 and the second pivot axis 82) between and to a first longitudinal end 128 of the first hinge member body 122 and a second longitudinal end 130 of the first hinge member body 122. The first hinge member body 122 extends laterally (e.g., orthogonal to the longitudinal direction) between and to a first lateral side 132 of the first hinge member body 122 and a second lateral side 134 of the first hinge member body 122. The pylon hinge attachment members 124 are formed by or otherwise attached to the first hinge member body 122 on the first lateral side 132. The pylon hinge attachment members 124 project laterally outward from the first lateral side 132. The pylon hinge attachment members 124 may be arrayed longitudinally along the first lateral side 132. Each of the pylon hinge attachment members 124 forms a hinge aperture 136 extending along a respective one of the first pivot axis 76 or the second pivot axis 82. The IFS hinge attachment members 126 are formed by or otherwise attached to the first hinge member body 122 on the first lateral side 132. The IFS hinge attachment members 126 project laterally outward from the first lateral side 132. The IFS hinge attachment members 124 may be arrayed longitudinally along the first lateral side 132. For example, the IFS hinge attachment members 126 may be alternatingly arrayed along the first lateral side 132 with the pylon hinge attachment members 124. Each of the IFS hinge attachment members 126 forms a hinge aperture 138 extending along a respective one of the first pivot axis 76 or the second pivot axis 82. Each of the pylon hinge attachment members 124 and the IFS hinge attachment members 126 may include a single hinge attachment body or a pair of longitudinally-spaced hinge attachment bodies. For example, each of the pylon hinge attachment members 124 of FIG. 7 includes a pair of longitudinally-spaced hinge attachment bodies and each of the IFS hinge attachment members 126 of FIG. 7 includes a single hinge attachment body.

The second hinge member 62B includes a second hinge member body 140 and one or more OFS hinge attachment members 142. The second hinge member body 140 extends longitudinally (e.g., in a direction of the first pivot axis 76 and the second pivot axis 82) between and to a first longitudinal end 144 of the second hinge member body 140 and a second longitudinal end 146 of the second hinge member body 140. The second hinge member body 140 extends laterally (e.g., orthogonal to the longitudinal direction) between and to a first lateral side 148 of the second hinge member body 140 and a second lateral side 150 of the second hinge member body 140. The second hinge member body 140 extends vertically (e.g., orthogonal to the longitudinal direction and the lateral direction) between and to an upper side 152 of the second hinge member body 140 and a lower side 154 of the second hinge member body 140. The OFS hinge attachment members 142 are formed by or otherwise attached to the second hinge member body 140 on the upper side 152. The OFS hinge attachment members 142 project vertically upward from the upper side 152. The OFS hinge attachment members 142 may be arrayed longitudinally along the upper side 152. Each of the OFS hinge attachment members 142 forms a hinge aperture 156 extending along a respective one of the first pivot axis 76 or the second pivot axis 82. Each of the OFS hinge attachment members 142 may include a single hinge attachment body or a pair of longitudinally-spaced hinge attachment bodies. For example, each of the OFS hinge attachment members 142 of FIG. 7 includes a pair of longitudinally-spaced hinge attachment bodies.

The first hinge member 62A is pivotably mounted to the pylon 46 (not shown in FIGS. 7 and 8; see FIGS. 4-6) along a respective one of the first pivot axis 76 or the second pivot axis 82. Each of the pylon hinge attachment members 124 is pivotably mounted to the pylon 46 by a hinge pin 158 along the respective one of the first pivot axis 76 or the second pivot axis 82 (e.g., through the hinge aperture 136). The second hinge member 62B is pivotably mounted to the first hinge member 62A along the respective one of the first pivot axis 76 or the second pivot axis 82. Each of the OFS hinge attachment members 142 is pivotably mounted to a respective one of the IFS hinge attachment members 126 by a hinge pin 160 along the respective one of the first pivot axis 76 or the second pivot axis 82 (e.g., through the hinge aperture 138 and the hinge aperture 156). A respective one of the first body half 66 or the second body half 68 (see FIGS. 4-6) may be fixedly mounted to the first hinge member 62A, for example, at (e.g., on, adjacent, or proximate) the second lateral side 134. A respective one of the first body half 88 or the second body half 90 (e.g., the panel portion 94) may be fixedly mounted to the second hinge member 62B, for example, at (e.g., on, adjacent, or proximate) the first lateral side 148 and the lower side 154 as shown in FIG. 8.

In some embodiments, the hinge assembly 62 may include a seal 162. The seal 162 may be configured, for example, as an omega seal as shown in FIGS. 7-8. The seal 162 of FIGS. 7-8 is fixedly mounted to the second hinge member body 140 at (e.g., on, adjacent, or proximate) the second lateral side 150. The seal 162 extends lengthwise along the second lateral side 150 in the longitudinal direction. The seal 162 is configured to contact the first hinge member body 122 (e.g., the first lateral side 132) with the outer fixed structure 58 and the inner fixed structure 60 in their respective closed conditions to facilitate formation of a fluid seal between the first hinge member body 122 and the second hinge member body 140. While the seal 162 of FIGS. 7-8 is mounted to the second hinge member body 140, the seal 162 may alternatively be mounted on the first hinge member body 122 (e.g., along the first lateral side 132).

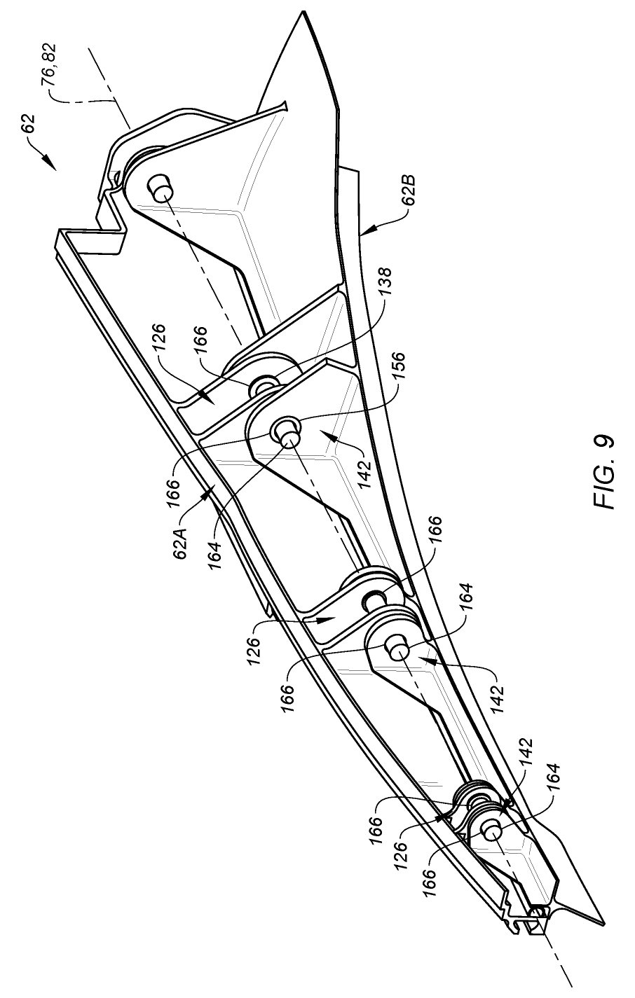

Referring to FIG. 9, in some embodiments, each of the IFS hinge attachment members 126 may be pivotably mounted to the pylon 46 (not shown in FIG. 9; see FIGS. 4-6) by a hinge pin 164 along the respective one of the first pivot axis 76 or the second pivot axis 82 (e.g., through the hinge apertures 138, 156). Each of the OFS hinge attachment members 142 may be pivotably mounted to a respective one of the IFS hinge attachment members 126 by the hinge pin 164 along the respective one of the first pivot axis 76 or the second pivot axis 82 (e.g., through the hinge apertures 138, 156). Accordingly, in some embodiments, the first hinge member 62A may not include the pylon hinge attachment members 124.

In some embodiments, the hinge assembly 62 may include a plurality of support bushings 166. Each of the support bushings 166 may be positioned on one of the IFS hinge attachment members 126 and a respective one of the OFS hinge attachment members 142, for example, at (e.g., on, adjacent, or proximate) the hinge aperture 138 and the hinge aperture 156. The support bushings 166 may be positioned between the hinge pin 164 (or the hinge pins 158, 160) and the hinge attachment members 126, 142 to facilitate pivoting of the outer fixed structure 58 and the inner fixed structure 60 (see FIGS. 4-6) between and to their respective closed conditions and open conditions.

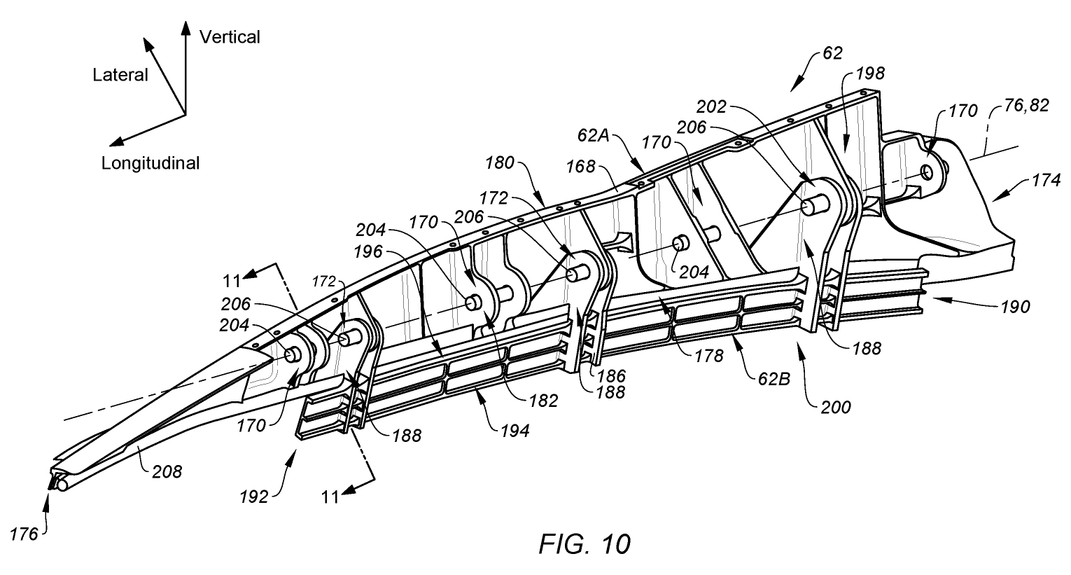

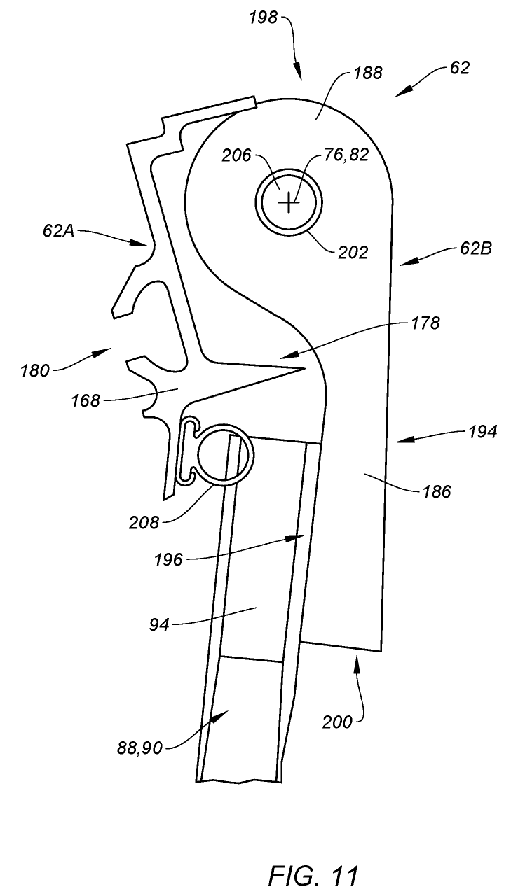

FIGS. 10-11 illustrate an embodiment of the hinge assembly 62. FIG. 10 illustrates a perspective view of one of the first hinge members 62A and a respective one of the second hinge members 62B. FIG. 11 illustrates a cross-sectional view of the first hinge member 62A and the second hinge member 62B of FIG. 10 taken along Line 11-11 of FIG. 10.

The first hinge member 62A includes a first hinge member body 168, one or more pylon hinge attachment members 170, and one or more IFS hinge attachment members 172. The first hinge member body 168 extends longitudinally (e.g., in a direction of the first pivot axis 76 and the second pivot axis 82) between and to a first longitudinal end 174 of the first hinge member body 168 and a second longitudinal end 176 of the first hinge member body 168. The first hinge member body 168 extends laterally (e.g., orthogonal to the longitudinal direction) between and to a first lateral side 178 of the first hinge member body 168 and a second lateral side 180 of the first hinge member body 168. The pylon hinge attachment members 170 are formed by or otherwise attached to the first hinge member body 168 on the first lateral side 178. The pylon hinge attachment members 170 project laterally outward from the first lateral side 178. The pylon hinge attachment members 170 may be arrayed longitudinally along the first lateral side 178. Each of the pylon hinge attachment members 170 forms a hinge aperture 182 extending along a respective one of the first pivot axis 76 or the second pivot axis 82. The IFS hinge attachment members 172 are formed by or otherwise attached to the first hinge member body 168 on the first lateral side 178. The IFS hinge attachment members 172 project laterally outward from the first lateral side 178. The IFS hinge attachment members 172 may be arrayed longitudinally along the first lateral side 178. For example, the IFS hinge attachment members 172 may be alternatingly arrayed along the first lateral side 178 with the pylon hinge attachment members 170. Each of the IFS hinge attachment members 172 forms a hinge aperture 184 extending along a respective one of the first pivot axis 76 or the second pivot axis 82. Each of the pylon hinge attachment members 170 and the IFS hinge attachment members 172 may include a single hinge attachment body or a pair of longitudinally-spaced hinge attachment bodies. For example, each of the pylon hinge attachment members 170 of FIG. 10 includes a pair of longitudinally-spaced hinge attachment bodies and each of the IFS hinge attachment members 172 of FIG. 10 includes a pair of longitudinally-spaced hinge attachment bodies.

The second hinge member 62B includes a second hinge member body 186 and one or more OFS hinge attachment members 188. The second hinge member body 186 extends longitudinally (e.g., in a direction of the first pivot axis 76 and the second pivot axis 82) between and to a first longitudinal end 190 of the second hinge member body 186 and a second longitudinal end 192 of the second hinge member body 186. The second hinge member body 186 extends laterally (e.g., orthogonal to the longitudinal direction) between and to a first lateral side 194 of the second hinge member body 186 and a second lateral side 196 of the second hinge member body 186. The second hinge member body 186 extends vertically (e.g., orthogonal to the longitudinal direction and the lateral direction) between and to an upper side 198 of the second hinge member body 186 and a lower side 200 of the second hinge member body 186. The OFS hinge attachment members 188 are formed by or otherwise attached to the second hinge member body 186 on the upper side 198. The OFS hinge attachment members 188 may be arrayed longitudinally along the upper side 198. Each of the OFS hinge attachment members 188 forms a hinge aperture 202 extending along a respective one of the first pivot axis 76 or the second pivot axis 82. Each of the OFS hinge attachment members 188 may include a single hinge attachment body or a pair of longitudinally-spaced hinge attachment bodies. For example, each of the OFS hinge attachment members 188 of FIG. 10 includes a pair of longitudinally-spaced hinge attachment bodies.

The first hinge member 62A is pivotably mounted to the pylon 46 (not shown in FIGS. 10 and 11; see FIGS. 4-6) along a respective one of the first pivot axis 76 or the second pivot axis 82. Each of the pylon hinge attachment members 170 is pivotably mounted to the pylon 46 by a hinge pin 204 along the respective one of the first pivot axis 76 or the second pivot axis 82 (e.g., through the hinge aperture 182). The second hinge member 62B is pivotably mounted to the first hinge member 62A along the respective one of the first pivot axis 76 or the second pivot axis 82. Each of the OFS hinge attachment members 188 is pivotably mounted to a respective one of the IFS hinge attachment members 172 by a hinge pin 206 along the respective one of the first pivot axis 76 or the second pivot axis 82 (e.g., through the hinge aperture 184 and the hinge aperture 202). A respective one of the first body half 66 or the second body half 68 (see FIGS. 4-6) may be fixedly mounted to the first hinge member 62A, for example, at (e.g., on, adjacent, or proximate) the second lateral side 180. A respective one of the first body half 88 or the second body half 90 (e.g., the panel portion 94) may be fixedly mounted to the second hinge member 62B, for example, at (e.g., on, adjacent, or proximate) the second lateral side 196 and the lower side 200 as shown in FIG. 11.

In some embodiments, the hinge assembly 62 may include a seal 208. The seal 208 may be configured, for example, as an omega seal as shown in FIGS. 10-11. The seal 208 of FIGS. 10-11 is fixedly mounted to the first hinge member body 168 at (e.g., on, adjacent, or proximate) the first lateral side 178. The seal 208 extends lengthwise along the first lateral side 178 in the longitudinal direction. The seal 208 is configured to contact a respective one of the first body half 88 or the second body half 90 (e.g., the panel portion 94) with the outer fixed structure 58 and the inner fixed structure 60 in their respective closed conditions to facilitate formation of a fluid seal between the first hinge member body 168 and the second hinge member body 186.

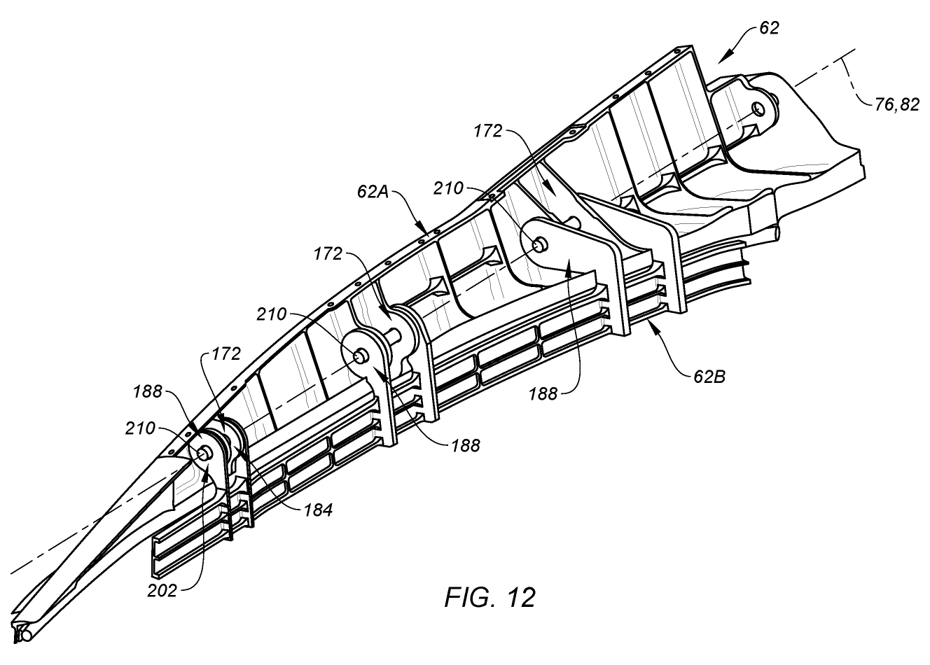

Referring to FIG. 12, in some embodiments, each of the IFS hinge attachment members 172 may be pivotably mounted to the pylon 46 (not shown in FIG. 12; see FIGS. 4-6) by a hinge pin 210 along the respective one of the first pivot axis 76 or the second pivot axis 82 (e.g., through the hinge apertures 184, 202). Each of the OFS hinge attachment members 188 may be pivotably mounted to a respective one of the IFS hinge attachment members 172 by the hinge pin 210 along the respective one of the first pivot axis 76 or the second pivot axis 82 (e.g., through the hinge apertures 184, 202). Accordingly, in some embodiments, the first hinge member 62A may not include the pylon hinge attachment members 170.

While the principles of the disclosure have been described above in connection with specific apparatuses and methods, it is to be clearly understood that this description is made only by way of example and not as limitation on the scope of the disclosure. Specific details are given in the above description to provide a thorough understanding of the embodiments. However, it is understood that the embodiments may be practiced without these specific details.

It is noted that the embodiments may be described as a process which is depicted as a flowchart, a flow diagram, a block diagram, etc. Although any one of these structures may describe the operations as a sequential process, many of the operations can be performed in parallel or concurrently. In addition, the order of the operations may be rearranged. A process may correspond to a method, a function, a procedure, a subroutine, a subprogram, etc.

The singular forms "a," "an," and "the" refer to one or more than one, unless the context clearly dictates otherwise. For example, the term "comprising a specimen" includes single or plural specimens and is considered equivalent to the phrase "comprising at least one specimen." The term "or" refers to a single element of stated alternative elements or a combination of two or more elements unless the context clearly indicates otherwise. As used herein, "comprises" means "includes." Thus, "comprising A or B," means "including A or B, or A and B," without excluding additional elements.

It is noted that various connections are set forth between elements in the present description and drawings (the contents of which are included in this disclosure by way of reference). It is noted that these connections are general and, unless specified otherwise, may be direct or indirect and that this specification is not intended to be limiting in this respect. Any reference to attached, fixed, connected, or the like may include permanent, removable, temporary, partial, full and/or any other possible attachment option.

No element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprise”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures--such as alternative materials, structures, configurations, methods, devices, and components, and so on--may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein. For example, in the exemplary embodiments described above within the Detailed Description portion of the present specification, elements may be described as individual units and shown as independent of one another to facilitate the description. In alternative embodiments, such elements may be configured as combined elements.

What is claimed is:

1. A thrust reverser assembly for an aircraft propulsion system, the thrust reverser assembly comprising:
a pylon;
an outer fixed structure extending about an axial centerline, the outer fixed structure forms an outer-radial boundary of a bypass flow path through the thrust reverser assembly, and the outer fixed structure includes a first outer body half;
an inner fixed structure extending about the axial centerline, the inner fixed structure forms an inner-radial boundary of the bypass flow path through the thrust reverser assembly, and the inner fixed structure includes a first inner body half; and
a hinge assembly including a first hinge member and a second hinge member, the first hinge member is pivotably mounted to the pylon about a first pivot axis, and the second hinge member is pivotably mounted to the first hinge member about the first pivot axis;
the first hinge member pivotably mounts the first outer body half to the pylon to pivot about the first pivot axis between a closed first outer body position and an open first outer body position, and the second hinge member pivotably mounts the first inner body half to the first outer body half to pivot about the first pivot axis between a closed first inner body position and an open first inner body position independent of the first outer body half.

2. The thrust reverser assembly of claim 1, wherein:
the outer fixed structure includes a second outer body half, the inner fixed structure includes a second inner body half, the hinge assembly includes a third hinge member and a fourth hinge member, the third hinge member is pivotably mounted to the pylon about a second pivot axis, and the fourth hinge member is pivotably mounted to the third hinge member about the second pivot axis; and
the third hinge member pivotably mounts the second outer body half to the pylon to pivot about the second pivot axis between a closed second outer body position and an open second outer body position, and the second hinge member pivotably mounts the second inner body half to the second outer body half to pivot about the second pivot axis between a closed second inner body position and an open second inner body position independent of the second outer body half.

3. The thrust reverser assembly of claim 2, wherein the outer fixed structure includes an outer latch assembly configured to secure the first outer body half and the second outer body half together in the closed first outer body position and the closed second outer body position, respectively, and the inner fixed structure includes an inner latch assembly configured to secure the first inner body half and the second inner body half together in the closed first inner body position and the closed second inner body position, respectively.

4. The thrust reverser assembly of claim 1, wherein the first hinge member includes a first hinge member body, the first hinge member body includes one or more inner fixed structure (IFS) attachment members, the second hinge member includes a second hinge member body, the second hinge member body includes one or more outer fixed structure (OFS) attachment members, and each of the OFS attachment members is pivotably mounted to a respective one of the IFS attachment members along the first pivot axis.

5. The thrust reverser assembly of claim 4, wherein the first hinge member body includes one or more pylon attachment members, and the pylon attachment members are pivotably mounted to the pylon along the first pivot axis.

6. The thrust reverser assembly of claim 4, wherein the IFS attachment members are pivotably mounted to the pylon along the first pivot axis.

7. The thrust reverser assembly of claim 6, wherein each of the OFS attachment members is pivotably mounted to the respective one of the IFS attachment members by a support bushing and a hinge pin, and the hinge pin is pivotably mounted to the pylon along the first pivot axis.

8. The thrust reverser assembly of claim 4, wherein the hinge assembly includes a seal mounted to the second hinge member body, and the first hinge member body contacts the seal with the first outer body half and the first inner body half in the closed first outer body position and the closed first inner body position, respectively.

9. The thrust reverser assembly of claim 4, wherein the hinge assembly includes a seal mounted to the first hinge member body, and the first inner body half contacts the seal with the first outer body half and the first inner body half in the closed first outer body position and the closed first inner body position, respectively.

10. A thrust reverser assembly for an aircraft propulsion system, the thrust reverser assembly comprising:
a pylon;
an outer fixed structure extending about an axial centerline, the outer fixed structure includes a first outer body half, a second outer body half, and an outer latch assembly, each of the first outer body half and the second outer body half is pivotable between a closed outer body position and an open outer body position, and the outer latch assembly is configured to retain the first outer body half and the second outer body half together with both of the first outer body half and the second outer body in the closed outer body position;
an inner fixed structure extending about the axial centerline, the inner fixed structure includes a first inner body half, a second inner body half, and an inner latch assembly, each of the first inner body half and the second inner body half is pivotable between a closed inner body position and an open inner body position, and the inner latch assembly is configured to retain the first inner body half and the second inner body half together with both of the first inner body half and the second inner body in the closed inner body position; and
a hinge assembly, the hinge assembly pivotably mounts the first outer body half to the pylon at a first pivot axis, the hinge assembly pivotably mounts the first inner body half to the first outer body half at the first pivot axis, the first outer body half and the first inner body half are independently pivotable about the first pivot axis, the hinge assembly pivotably mounts the second outer body half to the pylon at a second pivot axis, the hinge assembly pivotably mounts the second inner body half to the second outer body half at the second pivot axis, the second outer body half and the second inner body half are independently pivotable about the second pivot axis.

11. The thrust reverser assembly of claim 10, wherein each of the first outer body half and the second outer body half is pivotably mounted to the pylon by a first hinge member of the hinge assembly.

12. The thrust reverser assembly of claim 11, wherein each of the first inner body half and the second inner body half is pivotably mounted to the first outer body half and the second outer body half, respectively, by a second hinge member of the hinge assembly.

13. The thrust reverser assembly of claim 12, wherein the first hinge member and the second hinge member are pivotably mounted to the pylon by a support bushing.

14. The thrust reverser assembly of claim 12, wherein the second hinge member includes a seal, and the first hinge member is configured to contact the seal with the first outer body half and the second outer body half in the closed outer body position and the first inner body half and the second inner body half in the closed inner body position.

15. A thrust reverser assembly for an aircraft propulsion system, the thrust reverser assembly comprising:
a pylon;
an outer fixed structure extending about an axial centerline, the outer fixed structure forms an outer-radial boundary of a bypass flow path through the thrust reverser assembly, and the outer fixed structure includes a first outer body half;
an inner fixed structure extending about the axial centerline, the inner fixed structure forms an inner-radial boundary of the bypass flow path through the thrust reverser assembly, and the inner fixed structure includes a first inner body half; and
a hinge assembly including a first hinge member and a second hinge member, the first hinge member is pivotably mounted to the pylon along a first pivot axis, the first hinge member includes a first hinge member body, the first hinge member body includes one or more inner fixed structure (IFS) attachment members, the second hinge member includes a second hinge member body, the second hinge member body includes one or more outer fixed structure (OFS) attachment members, and each of the OFS attachment members is pivotably mounted to a respective one of the IFS attachment members along the first pivot axis.

16. The thrust reverser assembly of claim 15, wherein the first hinge member body includes one or more pylon attachment members, and the pylon attachment members are pivotably mounted to the pylon along the first pivot axis.

17. The thrust reverser assembly of claim 16, wherein the pylon attachment members are alternatingly arrayed with the IFS attachment members along the first pivot axis.

18. The thrust reverser assembly of claim 15, wherein the IFS attachment members are pivotably mounted to the pylon along the first pivot axis.

19. The thrust reverser assembly of claim 15, wherein the hinge assembly includes a seal mounted to the second hinge member body, and the first hinge member body is configured to contact the seal.

20. The thrust reverser assembly of claim 15, wherein the hinge assembly includes a seal mounted to the first hinge member body, and the first inner body half is configured to contact the seal.
